(19) United States
(12) Patent Application Publication
(10) Pub. No.: US 2021/0209273 A1
(43) Pub. Date: Jul. 8, 2021

(54) SIMULATION METHOD, SIMULATION APPARATUS, AND COMPUTER READABLE MEDIUM STORING PROGRAM

(71) Applicant: SUMITOMO HEAVY INDUSTRIES, LTD., Tokyo (JP)

(72) Inventor: Ryunosuke Kitahara, Kanagawa (JP)

(21) Appl. No.: 17/143,534

(22) Filed: Jan. 7, 2021

(30) Foreign Application Priority Data
Jan. 7, 2020 (JP) 2020-000676

(51) Int. Cl. G06F 30/25

(52) U.S. Cl. CPC G06F 30/25

(57) ABSTRACT

A simulation method includes coarse-graining a plurality of atoms that constitutes a magnetic body to be simulated and generating a magnetic body model composed of a collection of particles with a smaller number than an original number of the atoms; applying a magnetic moment to each of a plurality of the particles of the magnetic body model; determining an interparticle exchange interaction acting between the plurality of particles of the magnetic body model, based on an interatomic exchange interaction of the magnetic body; causing a magnetic field based on the interparticle exchange interaction to be included in the magnetic field acting on each of the plurality of particles; and time-evolving the magnetic moment of each of the plurality of particles, based on the magnetic field acting on each of the plurality of particles of the magnetic body model.

### RELATED APPLICATIONS

The content of Japanese Patent Application No. 2020-000676, on the basis of which priority benefits are claimed in an accompanying application data sheet, is in its entire incorporated herein by reference.

### BACKGROUND

### Technical Field

A certain embodiment of the present invention relates to a simulation method, a simulation apparatus, and a computer readable medium storing a program.

### Description of Related Art

As a method for simulating magnetization in a magnetic body, a micromagnetics method and an atomic spin method are known in the related art. In the micromagnetics method, a magnetic body is divided into meshes of several tens of nanometers and analyzed by the finite element method. In the atomic spin method, first-principle calculation is performed in consideration of the atomic arrangement at nanometer intervals and the atomic spin.

### SUMMARY

According to an embodiment of the present invention, there is provided a simulation method including:

coarse-graining a plurality of atoms that constitutes a magnetic body to be simulated and generating a magnetic body model composed of a collection of particles with a smaller number than an original number of the atoms,

applying a magnetic moment to each of a plurality of the particles of the magnetic body model;

determining an interparticle exchange interaction acting between the plurality of particles of the magnetic body model, based on an interatomic exchange interaction of the magnetic body;

causing a magnetic field based on the interparticle exchange interaction to be included in the magnetic field acting on each of the plurality of particles; and

time-evolving the magnetic moment of each of the plurality of particles, based on the magnetic field acting on each of the plurality of particles of the magnetic body model.

According to another embodiment of the present invention, there is provided a simulation apparatus including an input device to which simulation conditions including coarse-grained conditions are input;

a processing device that obtains a distribution of a magnetic moment of the magnetic body, based on the simulation conditions input to the input device; and

an output device,

in which the processing device

coarse-grains a plurality of atoms that constitutes a magnetic body to be simulated, based on the input coarse-grained conditions, and generating a magnetic body model composed of a collection of particles with a smaller number than an original number of the atoms,

applies the magnetic moment to each of a plurality of the particles of the magnetic body model;

determines an interparticle exchange interaction acting between the plurality of particles of the magnetic body model, based on an interatomic exchange interaction of the magnetic body to be simulated,

causes a magnetic field based on the interparticle exchange interaction to be included in the magnetic field acting on each of the plurality of particles,

time-evolves the magnetic moment of each of the plurality of particles, based on the magnetic field acting on each of the plurality of particles of the magnetic body model, and

outputs a simulation result to the output device.

According to a further embodiment of the present invention, there is provided a computer readable medium storing a program that causes a computer to realize:

a function of coarse-graining a plurality of atoms that constitutes a magnetic body to be simulated and generating a magnetic body model composed of a collection of particles with a smaller number than an original number of the atoms,

a function of applying a magnetic moment to each of a plurality of the particles of the magnetic body model;

a function of determining an interparticle exchange interaction acting between the plurality of particles of the magnetic body model, based on an interatomic exchange interaction of the magnetic body;

a function of causing a magnetic field based on the interparticle exchange interaction to be included in the magnetic field acting on each of the plurality of particles; and

a function of time-evolving the magnetic moment of each of the plurality of particles, based on the magnetic field acting on each of the plurality of particles of the magnetic body model.

### BRIEF DESCRIPTION OF THE DRAWINGS

FIG. 1A is a diagram schematically illustrating a plurality of atoms constituting a magnetic body to be simulated, and FIG. 1B is a diagram schematically illustrating a magnetic body model composed of a collection of coarse-grained particles with a smaller number than an original number of the atoms, by coarse-graining a plurality of atoms constituting the magnetic body illustrated in FIG. 1A.

FIG. 2 is a schematic diagram of an i-th particle and a j-th particle for explaining parameters V, W, and S.

FIG. 3 is a block diagram of a simulation apparatus according to an embodiment.

FIG. 4 is a flowchart of a simulation method according to the embodiment.

FIGS. 5A to 5D, 5F, and 5G are diagrams illustrating the distribution of directions of magnetic moments obtained by simulation in shades, and FIG. 5E is a diagram illustrating the directions of the magnetic moments illustrated in FIGS. 5A to 5D.

FIGS. 6A and 6B are diagrams illustrating the results of simulation with particle radii of 1 nm and 100 nm, respectively.

### DETAILED DESCRIPTION

In the micromagnetics method, it is difficult to perform an analysis in consideration of the interaction occurring in the microscopic region at the atomic level. The atomic spin method can reproduce microscopic physical phenomena, but the size of the calculation area that can be analyzed is small, and it is more difficult to analyze the magnetization of magnetic bodies such as magnetic heads and motor parts, due to limitation such as calculation time and memory capacity. In the atomic spin method described in the related art, a plurality of atoms are coarse-grained to reduce the number of particles to be calculated, thereby relaxing the limitation of the calculation area due to the calculation time, memory capacity, and the like. However, coarse-graining makes it impossible to reproduce the exchange interaction between atoms.

It is desirable to provide a simulation method, a simulation apparatus, and a computer readable medium storing a program, capable of expanding the size of a calculation area and reproducing the exchange interaction to analyze the distribution of magnetization.

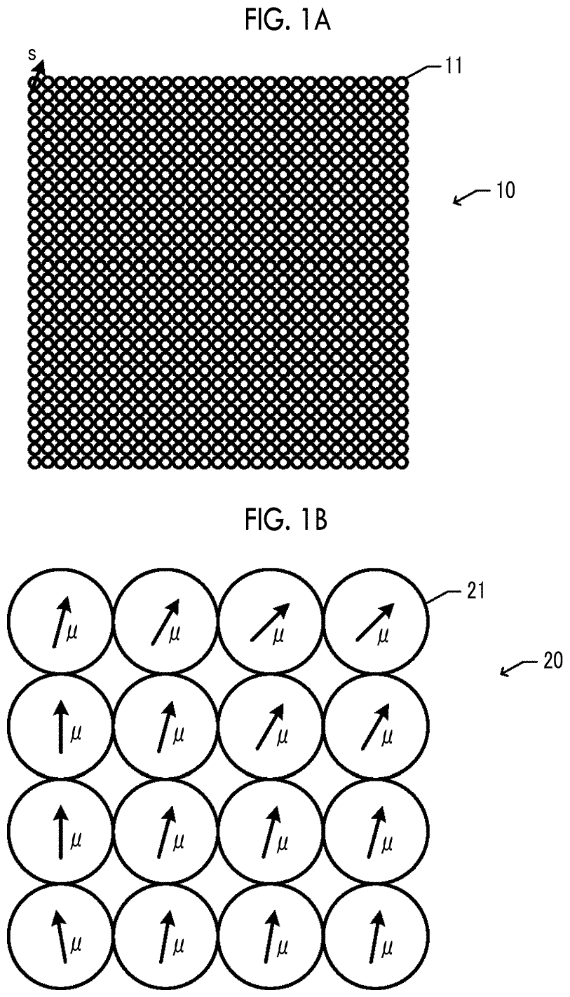

A simulation method and a simulation apparatus according to an embodiment will be described with reference to FIGS. 1A to 6B.

FIG. 1A is a diagram schematically illustrating a plurality of atoms 11 constituting a magnetic body 10 to be simulated. Actually, the plurality of atoms 11 are three-dimensionally distributed in the magnetic body 10, but FIG. 1A illustrates an example in which the plurality of atoms 11 are two-dimensionally distributed. In FIG. 1A, a plurality of atoms 11 located on one virtual plane in the magnetic body 10 are considered.

Each of the plurality of atoms 11 has an atomic spin s. The Hamiltonian H_{iexch} of the interatomic exchange interaction acting on the i-th atom 11 is defined by the following equation.

$${ℋ}_{i}^{exch} = - J {\sum }_{j}^{z} {s}_{i} \cdot {s}_{j} \qquad ( 1 )$$

Here, J is an exchange interaction intensity coefficient representing the intensity of the exchange interaction between atoms, sᵢ and sⱼ are atomic spins of the i-th and j-th atoms, respectively, and sigma means the sum of all the atoms 11 adjacent to the i-th atom 11. z is the number of atoms 11 adjacent to the i-th atom 11. Vectors are illustrated in bold in the drawings and in equations herein.

The magnetic field h_{iexch} due to the interatomic exchange interaction acting on the i-th atom 11 is expressed by the following equation.

$${h}_{i}^{e x c h} = - \frac{\partial {ℋ}_{i}^{e x c h}}{\partial {μ}_{i}} \qquad ( 2 )$$

Here, sᵢ in Equation (1) and μᵢ in Equation (2) have the following relationship.

μᵢ=−gμ_{B}sᵢ. . . (3)

Here, g is a g-factor, and usually the g-factor is about 2. μ_{B} is a Bohr magneton. μᵢ represents the magnetic moment of one atom.

FIG. 1B is a diagram schematically illustrating a magnetic body model 20 generated by coarse-graining a plurality of atoms 11 constituting the magnetic body 10 illustrated in FIG. 1A. The magnetic body model 20 consists of a collection of coarse-grained particles 21 with a smaller number than the number of atoms in the original magnetic body 10. A magnetic moment μ is applied to each of the plurality of particles 21, based on the atomic spins s of the atoms 11 in the magnetic body 10. In the calculation, the magnetic moment μ of the particle 21 is, for example, a unit vector having a length of 1.

Next, a method of calculating a temporal change of the magnetic moment μ of each particle 21 in the magnetic body model 20 will be described.

The temporal change of the magnetic moments μ of the plurality of particles 21 can be expressed by the following Landau-Lifshits-Gilbert equation (LLG equation).

$$\frac{d μ}{d t} = - \frac{γ}{1 + {α}^{2}} μ \times h - \frac{αγ}{( 1 + {α}^{2} ) \vert μ \vert} μ \times ( μ \times h ) \qquad ( 4 )$$

Here, h is a magnetic field acting on the particles 21, α is an attenuation constant, and γ is a magnetic rotation ratio.

The magnetic moment μ(t+Δt) at time t+Δt is expressed by the following equation using the magnetic moment μ(t) at time t.

$$μ ( t + Δ t ) = μ ( t ) + \frac{d μ}{d t} \cdot Δt \qquad ( 5 )$$

The magnetic field hᵢ acting on the i-th particle 21 includes the external magnetic field hᵢₑₓₜ, magnetic field h_{idipole} due to uniaxial crystal anisotropic interaction, and the magnetic field hᵢₐₙᵢₛ due to dipole interaction. The magnetic field h_{idipole} due to uniaxial crystal anisotropic interaction, and the magnetic field hᵢₐₙᵢₛ due to dipole interaction can be expressed by the following equation.

$${h}_{i}^{d i p o l e} = \frac{1}{4 π} {\sum }_{j} ( \frac{3 ( {μ}_{j} \cdot {\hat{r}}_{ij} ) {\hat{r}}_{ij} - {μ}_{j}}{{r}_{ij}^{3}} ) \\ {h}_{i}^{a n i s} = 2 K ( {μ}_{i} \cdot e ) e \qquad ( 6 )$$

Here, the rᵢⱼ hat is a unit vector parallel to the vector whose starting point is the position of the j-th particle 21 and the ending point is the position of the i-th particle 21. rᵢⱼ is the distance from the j-th particle 21 to the i-th particle 21. μⱼ is the magnetic moment of the j-th particle 21. e is a magnetization-friendly axis vector, and K is a magnetic anisotropy constant.

When it is assumed that the external magnetic field hᵢₑₓₜ, the magnetic field h_{idipole} by uniaxial crystal anisotropy interaction, and the magnetic field hᵢₐₙᵢₛ by dipole interaction act on the particle 21, the magnetic field h_{iexch} (Equation (2)) due to interatom interaction acting on atoms 11 in the magnetic body 10 in (FIG. 1A) is not reproduced in the magnetic body model 20. In the present embodiment, it is assumed that an interparticle exchange interaction equivalent to an interatomic exchange interaction acts between the particles 21.

The Hamiltonian of the interparticle exchange interaction between coarse-grained particles is defined as follows.

$${ℋ}_{i}^{e x c h} = - {J ( \frac{W \cdot S}{V} )}^{2} {\sum }_{j}^{z} {μ}_{i} \cdot {μ}_{j} \qquad ( 7 )$$

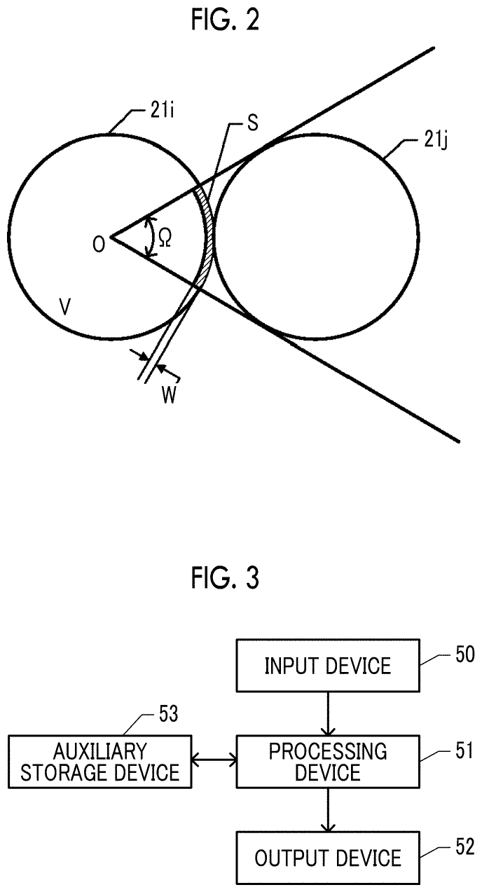

J is the same as the exchange interaction intensity coefficient J of Equation (1). The parameters V, W, and S will be described with reference to FIG. 2. μᵢ and μⱼ are magnetic moments of the i-th and j-th particles 21, respectively.

FIG. 2 is a schematic diagram of the i-th particle 21i and the j-th particle 21j for explaining the parameters V, W, and S. The particles 21i and 21j are adjacent to each other. The V on the right side of Equation (7) represents the volume of the particle 21i. S represents the surface area of the particle 21i in the range of the solid angle Ω that allows the other particle 21j to be seen from the center O of the one particle 21i. W is a parameter having a dimension of length. For example, as the value of W, the thickness of a single atomic layer located on the surface of the particles 21i can be adopted. In this case, the value of W is equal to the diameter of the atom 11 of the magnetic body 10 (FIG. 1A). In FIG. 2, hatching is attached to a portion corresponding to the volume of W·S.

Next, the physical meaning of Equation (7) will be described.

In the magnetic body 10, an interatomic exchange interaction acts between the atoms 11 adjacent to each other. The particles 21 of the magnetic body model 20 (FIG. 1B) are considered to represent a plurality of atoms 11. When the interparticle interaction acting between two particles 21 is defined by using Equation (1), the state in which the interatomic exchange action is working between two atoms 11 which are not adjacent to each other in the magnetic body 10 is reproduced. Therefore, it is considered that the interparticle exchange interaction works only between portions facing each other at a short distance, among the surfaces of the particles 21 adjacent to each other. In the present embodiment, a surface within a solid angle Ω that allows the other particle 21j to be seen from the center O of one particle 21i is adopted as the “portions facing each other at a short distance”.

Further, considering that only the atoms of one atomic layer located on the surface contribute to the interparticle exchange interaction, the volume of the portion contributing to the interparticle exchange interaction is represented by W·S. The term (W·S/V) on the right side of Equation (7) corresponds to the ratio of the volume of the portion contributing to the interparticle exchange interaction to the volume of the particles (hereinafter referred to as an effective volume ratio). In the calculation of the Hamiltonian H_{iexch} of the interparticle exchange interaction, the magnetic moments μᵢ and μⱼ of the two particles 21i and 21j that exert the interparticle exchange interaction are multiplied by the effective volume ratio, and weakend magnetic moment is used. That is, in the simulation of the magnetic body model 20 (FIG. 1), the entire magnetic moments μ of the particles 21 do not contribute to the interparticle exchange interaction, but weakened magnetic moments (W·S/V) μ according to the effective volume ratio are considered to contribute to the interparticle exchange interaction.

The magnetic field hᵢ acting on the i-th particle 21i can be obtained by the following equation.

hᵢ=hᵢ^{ext}+hᵢ^{dipole}+hᵢ^{anis}+hᵢ^{exch} (8)

The external magnetic field hᵢₑₓₜ is generated in the entire region to be calculated and is given as a simulation condition. The magnetic field h_{idipole} due to uniaxial crystal anisotropy interaction, and the magnetic field hᵢₐₙᵢₛ due to dipole interaction can be calculated using Equation (6).

The magnetic field h_{iexch} due to the interparticle exchange interaction can be expressed by the following equation, by using the Hamiltonian of the interparticle exchange interaction defined by Equation (7).

$${h}_{i}^{e x c h} = - \frac{\partial {ℋ}_{i}^{exch}}{\partial {μ}_{i}} \qquad ( 9 )$$

A magnetic field hᵢ acting on the i-th particle 21i is calculated using Equations (6), (8), and (9), dμ/dt is obtained from the results and Equation (4). The magnetic moments μ are time-evolved using the obtained dμ/dt and Equation (5).

FIG. 3 is a block diagram of a simulation apparatus according to an embodiment. The simulation apparatus according to the embodiment includes an input device 50, a processing device 51, an output device 52, and an external storage device 53. Simulation conditions or the like are input from the input device 50 to the processing device 51. Further, various commands or the like are input from the operator to the input device 50. The input device 50 includes, for example, a communication device, a removable media reading device, a keyboard, or the like.

The processing device 51 performs simulation calculation based on the input simulation conditions and commands. The processing device 51 is a computer including a central processing unit (CPU), a main storage device (main memory), and the like. The simulation program executed by the computer is stored in the external storage device 53. For the external storage device 53, for example, a hard disk drive (HDD), a solid state drive (SSD), or the like is used. The processing device 51 reads the program stored in the external storage device 53 into the main storage device and executes the program.

The processing device 51 outputs the simulation result to the output device 52. The simulation result includes information indicating the state (position, velocity, magnetic moment) of a plurality of particles representing the member to be analyzed, the temporal change of the physical quantity of the particle system composed of the plurality of particles, or the like. The output device 52 includes, for example, a communication device, a removable media writing device, a display, and the like.

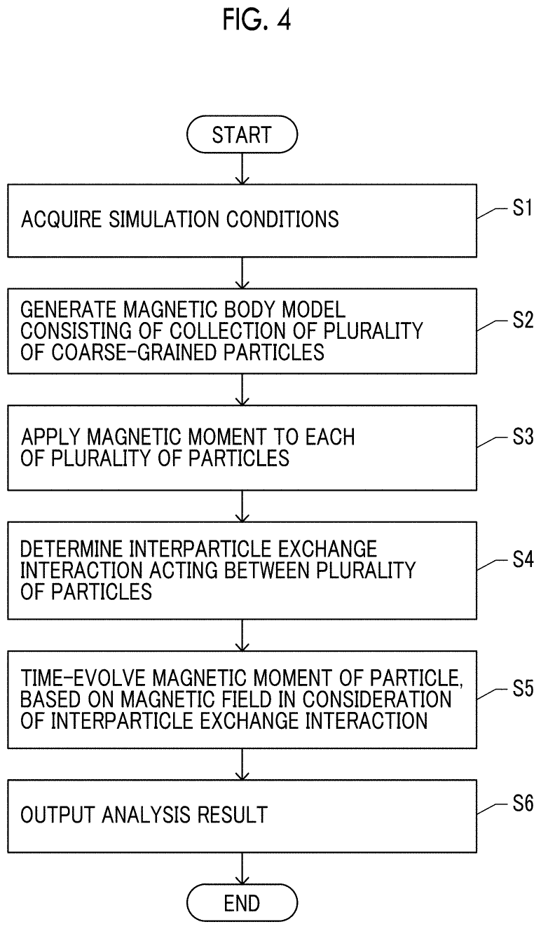

FIG. 4 is a flowchart of a simulation method according to the embodiment.

First, the processing device 51 acquires the simulation conditions input to the input device 50 (step S1). The simulation conditions include the physical property values of the magnetic body 10 (FIG. 1A) to be simulated, the shape of the magnetic body 10, the external magnetic field, the coarse-grained conditions, the initial conditions, the time step width in the simulation calculation, and the like.

When the processing device 51 acquires the simulation conditions, the processing device 51 generates the magnetic body model 20 (FIG. 1B), based on the acquired simulation conditions (step S2). Thus, the magnitude and position of the plurality of coarse-grained particles 21 (FIG. 1B) are determined. Further, a magnetic moment μ is applied to each of the plurality of particles 21 (step S3). The direction of the magnetic moment μ is set at random, for example.

After applying the magnetic moment μ to each particle 21, a magnetic moment μ of each of the plurality of particles 21 is time-evolved, based on the magnetic field hᵢ in consideration of the magnetic field h_{iexch} due to the interparticle exchange interaction (step S4). The calculation in step S4 is repeated until the end condition is satisfied. For example, when the magnetization state of the magnetic body model 20 becomes a steady state, the iterative process of step S4 is completed. When the end condition is satisfied, the processing device 51 outputs the analysis result to the output device 52 (step S5). As the analysis result, for example, the distribution of the directions of the magnetic moments μ may be displayed by a plurality of arrows, or the distribution of the directions of the magnetic moments μ may be displayed in shades of color or the like.

Next, the excellent effects of the above embodiment will be described.

In the above embodiment, the calculation time can be shortened by coarse-graining the plurality of atoms 11 of the magnetic body 10. Between a plurality of coarse-grained particles 21 (FIG. 1B), the interparticle exchange interaction corresponding to an exchange interaction acting between atoms is defined by Equation (7), and a magnetic field due to the interparticle exchange interaction is applied to each of the plurality of particles 21. Therefore, the temporal change of the magnetic moments of the magnetic body model 20 after coarse-graining can be simulated by appropriately reproducing the exchange interaction.

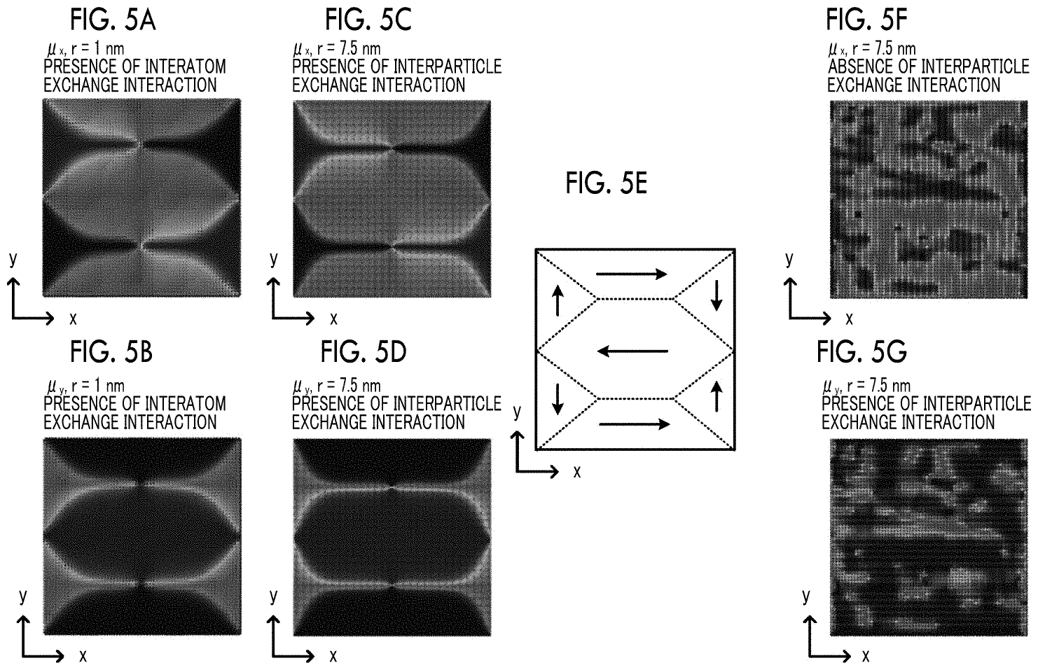

Next, with reference to FIGS. 5A to 5G, results of an actual simulation performed to check the excellent effect of the above embodiment will be described.

FIGS. 5A to 5D, 5F, and 5G are diagrams illustrating the distribution of the directions of magnetic moments obtained by simulation in shades. FIG. 5E is a diagram schematically illustrating the directions of the magnetic moments illustrated in FIGS. 5A to 5D. The calculation area in the simulation is a two-dimensional square with a side length of 50 nm. An xy Cartesian coordinate system is defined in the calculation area. When the radii of the coarse-grained particles 21 is 1 nm and 7.5 nm, respectively, the magnetic moments are time-evolved until the magnetic moment distribution of the particles 21 reaches a steady state. The particles 21 are arranged at the positions of the lattice points of the square lattice, and as initial conditions, the distribution of the directions of the magnetic moments are the same in all of FIGS. 5A to 5D, 5F, and 5G.

FIGS. 5A and 5B illustrate the simulation results of the magnetic moments when the radii r of the coarse-grained particles 21 is 1 nm. FIGS. 5C, 5D, 5F, and 5G illustrate the simulation results of the magnetic moments when the radii r of the coarse-grained particles 21 are 7.5 nm. Note that FIGS. 5F and 5G illustrate the results of simulations performed under the condition that the interparticle exchange interaction does not work between the coarse-grained particles 21.

FIGS. 5A, 5C, and 5F illustrate the magnitudes of the y components of the magnetic moments, and FIGS. 5B, 5D, and 5G illustrate the magnitudes of the x components of the magnetic moments. The region where the absolute values of the x and y components of the magnetic moments are large is illustrated relatively dark. The outline of the direction of the magnetic moment of each region divided by shading in FIGS. 5A to 5D is illustrated by an arrow in FIG. 5E.

In the simulations in which the interparticle exchange interaction is considered, the results of simulation (FIGS. 5A and 5B) with the particle radius r set to 1 nm and the results of simulation (FIGS. 5C and 5D) with the particle radius r set to 7.5 nm, a clear magnetic domain structure with aligned magnetic moment direction is checked. On the other hand, the magnetic domain structure does not appear in the results of the simulation (FIGS. 5F and 5G) in which the interparticle exchange interaction is not considered. From this simulation results, it can be seen that the interatomic exchange interaction of the magnetic body 10 to be simulated is appropriately reproduced in the coarse-grained magnetic body model 20.

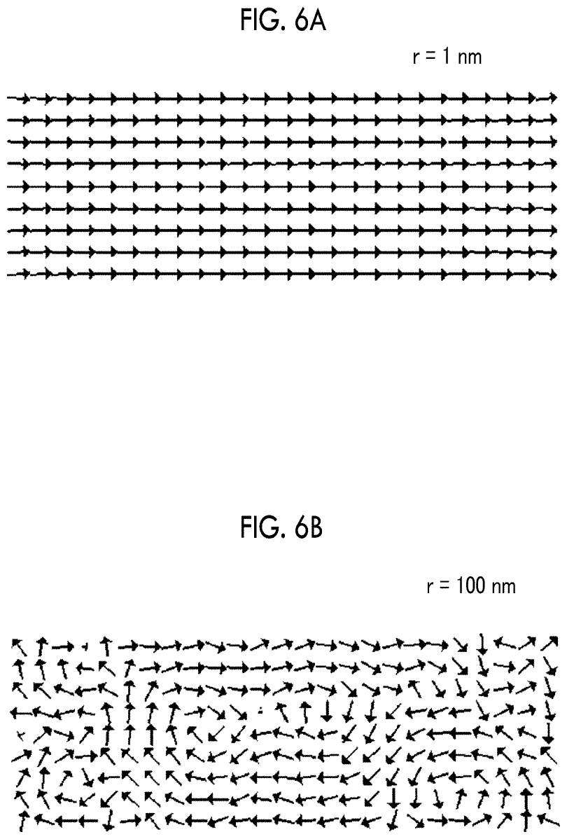

Next, the results of the simulation performed to check the degree of influence of the exchange interaction will be described with reference to FIGS. 6A and 6B.

FIGS. 6A and 6B are diagrams illustrating the results of simulation with the radii r of the particles 21 being 1 nm and 100 nm, respectively. In FIGS. 6A and 6B, the directions of the magnetic moments when the distribution of the magnetic moment reaches a steady state are indicated by arrows. The simulation area is a two-dimensional rectangle, and 24 and 9 particles 21 are arranged in the length direction and the width direction, respectively.

In the simulation results illustrated in FIG. 6A, the magnetic moments of all the particles 21 are oriented in substantially the same direction. This is because the interparticle exchange interaction works stronger than the uniaxial crystal anisotropic interaction and the dipole interaction. On the other hand, in the simulation result illustrated in FIG. 6B, the annular magnetic domain structure is checked. This is because the interparticle exchange interaction is relatively weakened, and the uniaxial crystal anisotropic interaction and the dipole interaction become apparent.

In both the simulations of FIGS. 6A and 6B, the number of target particles 21 is the same. Therefore, the calculation times for both are almost equal. Further, in the simulation of FIG. 6A, the rectangular region of 48 nm in width and 18 nm in length is the calculation target, whereas in the simulation of FIG. 6B, the rectangular region of 4800 nm in width and 1800 nm in length is the calculation target. In this way, by adopting the method according to the above embodiment, it is possible to expand the calculation area while suppressing the lengthening of the calculation time. Thus, it is possible to suppress an increase in calculation cost when simulating the magnetic moments of a large magnetic body.

Next, a modified example of the above embodiment will be described.

In the above embodiment, as illustrated in Equation (7), when determining the Hamiltonian of the interparticle exchange interaction, a value obtained by weakening the magnetic moment applied to the particles 21 according to the value of (W·S/V) is used. That is, the magnetic field due to the interparticle exchange interaction is calculated by weakening the interparticle exchange interaction. The coefficient for weakening the magnetic moment applied to the particle 21 is not limited to (W·S/V), and other coefficients less than 1 may be used. By weakening the interparticle exchange interaction, it is possible to make the uniaxial crystal anisotropic interaction and the dipole interaction apparent, while considering the interparticle exchange interaction. The coefficient for weakening the magnetic moment may be set to a value larger than 0 and smaller than 1, based on the magnitude and shape of the magnetic body 10 (FIG. 1A) to be simulated, the physical property value of the magnetic body, and the like.

The above-described embodiment is an example, and the present invention is not limited to the above-described embodiment. For example, it will be apparent to those skilled in the art that various modifications, improvements, combinations, and the like can be made.

It should be understood that the invention is not limited to the above-described embodiment, but may be modified into various forms on the basis of the spirit of the invention. Additionally, the modifications are included in the scope of the invention.

What is claimed is:

1. A simulation method comprising:
coarse-graining a plurality of atoms that constitutes a magnetic body to be simulated and generating a magnetic body model composed of a collection of particles with a smaller number than an original number of the atoms,
applying a magnetic moment to each of a plurality of the particles of the magnetic body model;
determining an interparticle exchange interaction acting between the plurality of particles of the magnetic body model, based on an interatomic exchange interaction of the magnetic body;
causing a magnetic field based on the interparticle exchange interaction to be included in the magnetic field acting on each of the plurality of particles; and
time-evolving the magnetic moment of each of the plurality of particles, based on the magnetic field acting on each of the plurality of particles of the magnetic body model.

2. The simulation method according to claim 1,
wherein a Hamiltonian of the interatomic exchange interaction is defined as a value obtained by multiplying an inner product of magnetic moments of two atoms that exert the interatomic exchange interaction by an exchange interaction intensity coefficient representing an intensity of an exchange interaction between the atoms, and
a Hamiltonian of the interparticle exchange interaction is defined as a value obtained by multiplying the inner product of magnetic moments obtained by weakening the magnetic moment applied to one particle and the magnetic moment applied to the other particle by the exchange interaction intensity coefficient.

3. The simulation method according to claim 2,
wherein magnetic moments of two particles which exert the interparticle exchange interaction are weakened, based on a ratio of a surface area within a range of a solid angle from a center of one particle that allows the other particle to be seen, among particles exerting the interparticle exchange interaction, and a volume of each of the plurality of particles.

4. The simulation method according to claim 1,
wherein a Landau-Lifshits-Gilbert equation is applied when the magnetic moment of each of the plurality of particles is time-evolved.

5. The simulation method according to claim 2,
wherein a Landau-Lifshits-Gilbert equation is applied when the magnetic moment of each of the plurality of particles is time-evolved.

6. The simulation method according to claim 3,
wherein a Landau-Lifshits-Gilbert equation is applied when the magnetic moment of each of the plurality of particles is time-evolved.

7. A simulation apparatus comprising:
an input device to which simulation conditions including coarse-grained conditions are input;
a processing device that obtains a distribution of a magnetic moment of the magnetic body, based on the simulation conditions input to the input device; and
an output device
wherein the processing device
coarse-grains a plurality of atoms that constitutes a magnetic body to be simulated, based on the input coarse-grained conditions, and generating a magnetic body model composed of a collection of particles with a smaller number than an original number of the atoms,
applies the magnetic moment to each of a plurality of the particles of the magnetic body model,
determines an interparticle exchange interaction acting between the plurality of particles of the magnetic body model, based on an interatomic exchange interaction of the magnetic body to be simulated,
causes a magnetic field based on the interparticle exchange interaction to be included in the magnetic field acting on each of the plurality of particles,
time-evolves the magnetic moment of each of the plurality of particles, based on the magnetic field acting on each of the plurality of particles of the magnetic body model, and
outputs a simulation result to the output device.

8. A computer readable medium storing a program that causes a computer to realize:
a function of coarse-graining a plurality of atoms that constitutes a magnetic body to be simulated and generating a magnetic body model composed of a collection of particles with a smaller number than an original number of the atoms,
a function of applying a magnetic moment to each of a plurality of the particles of the magnetic body model;
a function of determining an interparticle exchange interaction acting between the plurality of particles of the magnetic body model, based on an interatomic exchange interaction of the magnetic body;
a function of causing a magnetic field based on the interparticle exchange interaction to be included in the magnetic field acting on each of the plurality of particles; and
a function of time-evolving the magnetic moment of each of the plurality of particles, based on the magnetic field acting on each of the plurality of particles of the magnetic body model.
